(19) United States
(12) Patent Application Publication
(10) Pub. No.: US 2026/0042080 A1
(43) Pub. Date: Feb. 12, 2026

(54) SOLID SORBENT FOR REMOVAL OF CARBON DIOXIDE FROM A CO2-CONTAINING GAS

(71) Applicant: Sustaera Inc., Durham, NC (US)

(72) Inventors: Tyson Lee LANIGAN-ATKINS, Durham, NC (US); Cory Elliott SANDERSON, Wendell, NC (US); Jian Ping SHEN, Chapel Hill, NC (US); Raghubir Prasad GUPTA, Durham, NC (US)

(21) Appl. No.: 18/718,983

(22) PCT Filed: Jan. 17, 2024
(86) PCT No.: PCT/US2024/011749

§ 371 Date: Jun. 12, 2024

Related U.S. Application Data
(60) Provisional application No. 63/480,191, filed on Jan. 17, 2023.

(51) Int. Cl. B01J 20/22; B01D 53/04; B01J 20/04; B01J 20/28; B01J 20/30; B01J 20/32; B01J 20/34

(52) U.S. Cl. CPC B01J 20/22; B01D 53/0462; B01J 20/043; B01J 20/28042; B01J 20/3028; B01J 20/3204; B01J 20/345; B01D 2257/504; B01D 2259/40028

(57) ABSTRACT

A solid amino acid salt sorbent for removing CO₂ from a CO₂ containing gas comprises an amino acid constituent and an alkali metal constituent. The solid amino acid salt sorbent comprises one or more of potassium taurine salt, sodium proline salt, sodium taurine salt, sodium lysine salt, potassium lysine salt, lithium lysine salt, potassium glycine salt, sodium glycine salt, lithium glycine salt, histidine sodium salt, taurine sodium salt, aspartic acid sodium salt, asparagine sodium salt, alanine sodium salt, or leucine sodium salt. The sorbent may further comprise a support component arranged in a structural relationship with the amino acid and alkali metal constituents.

### CROSS-REFERENCE TO RELATED APPLICATIONS

This application claims the benefit of U.S. Provisional Patent Application No. 63/480,191 filed Jan. 17, 2023, the entire contents of which are incorporated by reference herein.

### STATEMENT OF FEDERALLY FUNDED RESEARCH

This invention was made with United States Government support under Cooperative Agreement Number DE-FE-3200118 awarded by the U.S. Department of Energy. The United States Government has certain rights in the invention.

### FIELD

The present disclosure generally relates to capture and removal of carbon dioxide from air and point source streams, and in various aspects relates to materials, assemblies, methods, and apparatus for direct air capture of carbon dioxide.

### DESCRIPTION OF THE RELATED ART

Carbon dioxide is a major greenhouse gas in the Earth's atmosphere that has consistently increased in the atmosphere in the Anthropocene era, from preindustrial concentrations on the order of 280 ppm by volume to the current atmospheric concentrations exceeding 415 ppm by volume. The generative causes and pernicious effects of such increasing levels of atmospheric carbon dioxide are well recognized, as including mediation of climatological increases in temperature, as well as progressive acidification of the planet's surface and subsurface waters, with consequent adverse effects on marine and freshwater lifeforms and habitat. Since carbon dioxide has a long atmospheric lifetime of hundreds to thousands of years, ambient carbon dioxide has become a focus of substantial concern and efforts to restrict CO₂ concentrations from increasing, by implementation of CO₂ abatement and sequestration technologies, and reduction, elimination, and replacement of existing sources of CO₂ emissions have intensified. In consequence, improvements in CO₂ capture, removal, and containment technologies are being sought to combat increasing ambient levels of carbon dioxide and associated adverse effects to which all plants, animals, and habitats on earth are ultimately and unavoidably exposed. CO₂ capture has been used to reduce CO₂ emissions from large stationary sources, such as fossil-fuel-based power stations, crude oil refineries, cement facilities, and iron or steel industry installations. Improvements in efficiency and effectiveness of CO₂ capture are needed. The direct extraction of CO₂ from ambient air is referred to herein as carbon dioxide removal (CDR) or direct air capture (DAC). Improvements in the efficiency and effectiveness of DAC are needed.

The current methods of removing CO₂ from air primarily utilize amine-based sorbents where CO₂ present in air is chemically reacted with an amine to form amine-CO₂ compounds like bicarbonate or carbamate. Once saturated with CO₂, the sorbent is generally regenerated with steam to desorb CO₂ by heating to temperatures around 100° C. and higher. Once regenerated, the sorbent is cooled for subsequent CO₂ adsorption. Cooling streams such as water vapor and nitrogen have been used to cool the sorbent after regeneration. Some commercial amine sorbents utilize amines that are supported on high surface area supports such as silica, and metal organic frameworks (MOFs) to provide high reaction rates for cyclic adsorption and desorption. Amine sorbents of such type are currently being commercially utilized in direct air capture (DAC) processes, such as those available from Climeworks AG (Zurich, Switzerland) and Global Thermostat, LLC (New York, NY). Some of these processes are described in U.S. Pat. Nos. 8,491,705 and 9,227,153 and U.S. patent application publication Nos. 2019/0291077A1 and 2022/0096991A1.

As demonstrated in “Chemical Kinetics of the Autoxidation of Poly(ethylenimine) in CO₂ Sorbents” by Iman Nezam, Jingwei Xie, Kristina W. Golub, Juliana Carneiro, Karl Olsen, Eric W. Ping, Christopher W. Jones, and Miles A. Sakwa-Novak at ACS Sustainable Chem. Eng. 2021, 9, 25, 8477-8486, https://pubs.acs.org/doi/10.1021/acssuschemeng.1c01367, as well as Si, W., Yang, B., Yu, Q., Lei, L., & Zhu, J. (2019); Deactivation Kinetics of Polyethylenimine-based Adsorbents Used for the Capture of Low Concentration CO₂. ACS omega, 4 (6), 11237-11244, https://doi.org/10.1021/acsomega.9b00792 and many others, it is well understood that solid amine sorbents for DAC of CO₂ degrade with exposure to oxygen at elevated temperatures seen during the thermal swing process of regeneration/desorption.

There has been considerable work investigating alkali metal sorbents for CO₂ capture and recently there has been more focus on using this sorbent class for DAC. Alkali metal sorbents for CO₂ capture are described in PCT Publication No. WO2014/012963A1 and U.S. Patent Application Publication No. 2019/0060820A1.

Using K- and Na-based sorbents for carbon dioxide capture from flue gases is described in Liang (Liang, Ya. “Carbon dioxide capture from flue gas using regenerable sodium-based sorbents.” (2003)) and Luo (Hongchao, Luo. “Fundamentals and Application in CO₂ Sorptivity of K2CO3 and Na2CO3.” (2015)).

Preparing amino acid alkali metal salts is described in U.S. Pat. No. 3,450,752. CO₂ absorption by amino acid ionic liquids is described in U.S. Pat. No. 10,130,911. PCT Publication No. WO2022/051598 further expands these teachings to inorganic carbonate and bicarbonate compounds for CO₂ capture, conversion, and storage by combining an alkaline oxide or hydroxide with an amine solvent used to capture the CO₂ which is stored as an alkaline carbonate or bicarbonate. In that work, the CO₂ capture is performed in a liquid slurry phase. Furthermore, Custelcean, R. et al. teach the use of aqueous amino acids with solid bisiminoguanidines (BIGs) for direct air capture of CO₂. Again, in this work, the CO₂ capture is performed in a liquid (aqueous) phase followed by room temperature regeneration to a solid, which releases the CO₂ in attempts to minimize amino acid losses from thermal and oxidative degradation. Bingbing Jiang et al. (“Development of amino acid and amino acid-complex based solid sorbents for CO₂ capture” (2013)) describe using solid amino acid sorbents dispersed on polymethylmethacrylate (PMMA) for CO₂ removal.

Physical adsorbents, such as zeolites and activated carbon, have been thoroughly studied for CO₂ removal/capture. U.S. Pat. No. 9,539,540 describes previous work of others. U.S. Pat. No. 8,591,627 describes low heat of adsorption/desorption of CO₂ but recognizes a downside of high water pickup on the sorbent as well, which increases the other energetics of the CO₂ removal process.

Climeworks describes a potassium carbonate and activated carbon hybrid sorbent for DAC of CO₂ in U.S. Patent Application Publication No. 2021/0187480A1. Also, preparation of an amine-grafted activated carbon sorbent is described in Houshmand, Amirhossein et al., Carbon Dioxide Capture with Amine-Grafted Activated Carbon https://link.springer.com/article/10.1007/s11270-011-0905-7.

In this context, there is a compelling need for sorbent materials that (1) can effectively capture CO₂ from air at ambient conditions in the presence of moisture and oxygen, (2) can be regenerated with reasonable desorption energy requirements, (3) can operate effectively for 3-5 years of continuous adsorption-regeneration cycles, (4) are relatively inexpensive, (5) are abundantly available to address gigaton/year CO₂ removal requirements, (6) can be readily implemented in process systems using existing manufacturing infrastructure, and (7) are environmentally benign.

### SUMMARY

The present disclosure relates to novel materials and a method for removing CO₂ from a gas stream using solid amino acid salt and/or amino sulfonic acid salt sorbents.

In a first aspect of the invention, a solid amino acid salt sorbent for removing CO₂ from a CO₂ containing gas comprises an amino acid constituent and an alkali metal constituent. In a feature of the first aspect, the amino acid constituent comprises one or more of an amino carboxylic acid or an amino sulfonic acid. The amino acid constituent may comprise one or more of taurine, proline, lysine, glycine, histidine, aspartic acid, asparagine, alanine, or leucine. In another feature of the first aspect, the alkali metal constituent comprises an alkali metal group element or alkaline earth metal group element from the periodic table. The alkali metal constituent may comprise one or more of potassium, sodium, or lithium. The solid amino acid salt sorbent may comprise one or more of potassium taurine salt, sodium proline salt, sodium taurine salt, sodium lysine salt, potassium lysine salt, lithium lysine salt, potassium glycine salt, sodium glycine salt, lithium glycine salt, histidine sodium salt, taurine sodium salt, aspartic acid sodium salt, asparagine sodium salt, alanine sodium salt, or leucine sodium salt.

In another feature of the first aspect, the solid amino acid salt sorbent further comprises a support component arranged in a structural relationship with the amino acid constituent and alkali metal constituent.

In a second aspect of the invention, a hybrid sorbent comprises a solid amino acid salt sorbent and an alkali metal sorbent. The alkali metal sorbent may comprise one or more of a hydroxide, carbonate, or bicarbonate of an alkali metal group element or alkaline earth metal group element from the periodic table. The alkali metal sorbent may comprise one or more of potassium, sodium, or lithium.

In a third aspect of the invention, a structured material assembly for removing CO₂ from a CO₂ containing gas comprises a substrate, a solid amino acid sorbent, and a support component arranged in a structural relationship with the sorbent. In a feature of this aspect, the structured material assembly further comprises a desorption material integrated into the structured material assembly, which is responsive to inputted energy to generate heat to desorb CO₂ from the sorbent.

In a fourth aspect of the invention, a process for removal of CO₂ from a CO₂-containing gas using a solid amino acid salt sorbent comprises providing an assembly comprising a solid amino acid salt sorbent, a support component, and a desorption material integrated into the assembly, wherein the solid amino acid salt sorbent comprises an amino acid constituent and an alkali metal constituent; contacting the CO₂-containing gas with the solid amino acid salt sorbent whereby CO₂ is adsorbed on the solid amino acid salt sorbent in an adsorption phase, and; heating the desorption material to desorb previously adsorbed CO₂ from the solid amino acid salt sorbent in a desorption phase. In the process, a single adsorption phase and a single desorption phase is a single CO₂ adsorption cycle.

### BRIEF DESCRIPTION OF THE DRAWINGS

FIG. 1 is a schematic representation of an amino acid precursor reacting with a base precursor (e.g., sodium hydroxide) to form an amino acid salt sorbent.

FIG. 2 is a chart showing CO₂ adsorption capacity as a function of cycles for two potassium-taurate coated substrates up to 1000 cycles.

FIG. 3 is a chart showing CO₂ adsorption capacity as a function of cycles for samples 2-3, 2-4, and 2-5.

FIG. 4 is a chart showing CO₂ adsorption capacity of samples 2-3, 2-4, and 3-1 as a function of desorption temperature.

FIG. 5 is a chart showing CO₂ adsorption capacity as a function of adsorption temperature.

FIG. 6 is a chart showing CO₂ adsorption capacity as a function of adsorption relative humidity at room temperature (16° C.).

FIG. 7 is a chart showing CO₂ adsorption capacity as a function of absolute humidity.

FIG. 8 is a chart showing CO₂ adsorption capacity in grams as a function of cycle number.

### DETAILED DESCRIPTION

The present disclosure relates generally to CO₂ sorbents for the capture or removal of CO₂ from any source or stream, including point source, industrial emissions, or from ambient air. In embodiments, a CO₂ sorbent or adsorbent can comprise an amino acid salt sorbent which comprises an amino acid and an alkali metal. The amino acid constituent may be an amino carboxylic acid or an amino sulfonic acid. The alkali metal constituent may be a hydroxide, carbonate, or bicarbonate form of an alkali metal group or alkaline earth metal group from the periodic table. The amino acid salt sorbent may be dispersed on a high surface area support.

As will be described in greater detail herein below, the amino acid salt sorbent possesses benefits over conventional CO₂ sorbents and meets the needs for CO₂ capture or removal. The amino acid salt sorbent has high CO₂ capacity and sorbent efficiency (molar ratio of CO₂/active site). In addition, the amino acid salt sorbent has relatively fast kinetics of CO₂ adsorption. In some conventional amino acid sorbents, CO₂ capture is performed in a liquid slurry phase. In contrast, the amino acid salt sorbent described herein is a solid sorbent, which improves sorbent lifetime and usability.

Advantageously, the amino acid salt sorbent has a lower regeneration energy demand for desorption of CO₂ captured on the sorbent than sorbents made from pure alkali metal carbonate.

The amino acid salt sorbent demonstrated high performance, having capacity and rate characteristics similar to organic sorbents (PEI) and having stability under oxidizing conditions (air and moisture) similar to an inorganic sorbent (alkali carbonate). In addition, the amino acid salt sorbent's thermal and oxidative stability is improved over organic amine-based sorbents. Stability in humid simulated air over 1000 cycles for amino acid salt sorbent supported on alumina mounted on a ceramic monolithic substrate with 80° C. regeneration is demonstrated in Example 2.

The amino acid salt sorbent captures and releases CO₂ primarily in a chemisorption-based process which is responsive to heat for regeneration or desorption of CO₂ making it ideal for relatively low temperature resistive heating. Resistive or Joule heating is a very efficient conversion of electricity to heat. The amino acid salt sorbent enthalpy and the temperature requirements for desorption of CO₂ from the amino acid salt sorbent are low enough to effectively release the CO₂ from the sorbent via resistive or Joule heating.

The amino acid salt sorbent is compatible with various high surface area supports such as alumina, silica, aluminosilicates, and carbons, which is important for integration into a substrate or particle for commercially relevant stability, cost, and scale.

As used herein and in the appended claims, the singular forms “a”, “an”, and “the” include plural referents unless the context clearly dictates otherwise.

As used herein, the terms “about” and “approximately” shall generally mean an acceptable degree of error for the quantity measured given the nature or precision of the measurements. Exemplary degrees of error are within 20-25 percent (%), typically, within 10%, and more typically, within 5% of a given value or range of values. The terms “about” and “approximately” include the recited value being modified; for example, “about 1.5” includes the recited value 1.5, as well as an acceptable degree of error around the recited value 1.5.

In the ensuing description, unless otherwise expressly stated, percentages pertaining to gas and fluid compositions are percentages by volume of the total gas or fluid volume, and percentages pertaining to solid compositions are percentages by weight of the total solid composition weight.

In the ensuing description, the terms “desorption” and “regeneration” are used interchangeably to mean removal of previously absorbed CO₂ from the sorbent to renew the sorbent for subsequent CO₂-removal use.

The disclosure, as variously set out herein in respect of features, aspects, and embodiments thereof, may, in particular implementations, be constituted as comprising, consisting, or consisting essentially of, some or all of such features, aspects and embodiments, as well as elements and components thereof being aggregated to constitute various further implementations of the disclosure. The disclosure is set out herein in various embodiments, and with reference to various features and aspects of the disclosure. The disclosure contemplates such features, aspects and embodiments in various permutations and combinations, as being within the scope of the invention. The disclosure may therefore be specified as comprising, consisting or consisting essentially of any of such combinations and permutations of these specific features, aspects and embodiments, or a selected one or ones thereof.

The amino acid salt sorbent comprises two constituents: an alkali sorbent and an amino acid sorbent of any suitable type or types combined to form an amino acid salt sorbent. A CO₂ sorbent referred to herein as an “amino acid salt sorbent” means a CO₂ sorbent having an alkali metal constituent and an amino acid constituent. In embodiments, the amino acid salt can have enhanced CO₂ sorption kinetic rates and/or total capture capacity over an alkali sorbent or amino acid sorbent alone. In embodiments, amino acid sorbents can include amino carboxylic acid salts and amino sulfonic acid salts.

In embodiments, the amino acid salt sorbent may comprise one or more of potassium taurate, alternatively potassium taurine, sodium prolinate, sodium taurate, sodium lysinate, potassium lysinate, lithium lysinate, potassium glycinate, sodium glycinate, lithium glycinate, histidine sodium salt, taurine sodium salt, aspartic acid sodium salt, asparagine sodium salt, alanine sodium salt, leucine sodium salt, or taurine potassium salt.

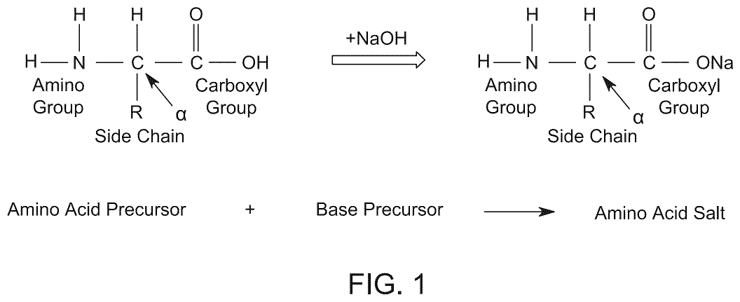

An amino acid salt for use as a CO₂ sorbent can be prepared through chemical reaction of an amino acid precursor with a base precursor, such as, alkali metal hydroxide or carbonate, for example, sodium hydroxide (NaOH), sodium carbonate (Na₂CO₃) or potassium hydroxide (KOH). This can be done in solid or solution form. In preferred embodiments, equimolar amounts of MOH (in aqueous solution), where M is Li, Na or K, and amino acid or amino sulfonic acid can be mixed to make an amino acid salt solution. Alternative molar ratios of MOH and amino acid can be combined. FIG. 1 provides a schematic representation of a reaction of an amino acid precursor with a base precursor (e.g., sodium hydroxide) to form an amino acid salt sorbent. As shown in FIG. 1, the molecule of amino acid used for making the sorbent has a structure with a carboxyl group, an amino group connecting to α-carbon, and a side chain.

Various amino acids with different side chains can serve as amino acid precursors for use in making amino acid salt sorbents. Suitable exemplary amino acids include, without limitation: (a) aliphatic side-chains, such as Glycine (H—), Alanine (CH₃—), Valine ((CH₃)₂CH—), Leucine ((CH₃)₂CHCH₂—), and proline (—CH₂CH₂CH₂—); (b) polar neutral side-chains, such as threonine; (c), amide side-chains, such as asparagine (NH₂COCH₂—); Glutamine (NH₂COCH₂CH₂—); (d) aromatic side-chains, such as tyrosine and tryptophan; (e) anionic side-chains, such as aspartate and glutamate; (f) cationic side-chains, such as histidine, lysine and arginine. Amino acids with other amino groups connecting to different locations of carbon such as β-, γ- and δ-position can also be employed for making amino acid salts. Other acids having a similar structure to amino acids but not a carboxyl group, such as, for example, having a sulfonic group (e.g., taurine) can also be used for making amino acid salts.

The use of amino acid salt sorbents for CO₂ capture has advantages over known CO₂ sorbents. The combination of amino acid and alkali metal to form an amino acid salt sorbent has benefits over previous CO₂ capture sorbents. The use of amino acids as a CO₂ capture agent (in addition to the alkali metal sorbent) leverages the high affinity of the amine site (NH₂⁻), like amine sorbents or solvents, towards CO₂ capture with reduced reactivity of the sorbent with oxygen, which is typically present in a CO₂ containing stream and is known in the art as a leading mechanism for sorbent degradation in polymeric amine sorbents and amine solvents. Additionally, by creating a solid sorbent from the amino acid salt, corrosion problems caused by high pH of alkanolamines in solution can be avoided, which can lead to costly maintenance issues.

Additionally, by selecting the appropriate amino acid and alkali metal constituents, the thermal degradation temperature of the amino acid salt can be tuned to work within the desired process operating window for desorption of CO₂ from the captured sites.

Furthermore, amino acid salts and their precursors and alkali metal oxides, as well as their byproducts, are naturally occurring compounds that are non-toxic and environmentally benign with lower volatility compared to amine sorbents or amine solvents (primary, secondary, or tertiary). This non-toxicity is critical to large-scale deployment of CO₂ capture for point source or direct air CO₂ containing streams to ensure minimal negative impact on human, animal, or environmental factors.

Moreover, the precursors for the amino acid salt sorbent are abundantly available and/or are produced in large quantities today compared to polymeric amines, enabling efficient mass production to achieve the necessary gigaton scale for CO₂ removal and capture markets to provide an effective climate impact.

In preferred embodiments, the amino acid salts are prepared in solution form with water as the solvent for impregnation coating of the CO₂ sorbent on a support followed by drying to produce a solid amino acid salt sorbent. By intentionally precipitating amino acid salt from amino acid in solution form and then drying the salt to form a solid CO₂ sorbent, problems related to unintentionally precipitating amino acid salts from liquid amino acid CO₂ solvents are avoided. Other drawbacks of solvent based absorption processes, such as, high energy requirements for sorbent regeneration due to the solvent thermal mass/sensible heating and enthalpy and volatility, which increases solvent consumption, are avoided by using a solid sorbent.

Additional processing techniques may be applied to improve adhesion and stability of the solid sorbent including the use of binders during coating, chemical bonding to a support and/or substrate, inert heat treatment, vacuum drying, and/or centrifugal drying.

As used herein, a “hybrid CO₂ sorbent” or a “hybrid sorbent” comprises two sorbent species, one of which is an amino acid salt sorbent. Thus, a hybrid CO₂ sorbent may comprise an alkali metal sorbent and an amino acid salt sorbent.

In embodiments, a hybrid sorbent for CO₂ capture can comprise an amino acid salt sorbent and an alkali sorbent. In one such embodiment, the hybrid sorbent may be a combination of potassium carbonate as the alkali sorbent and potassium taurine as the amino acid salt sorbent.

The combination of amino acid sorbent and alkali sorbent to create the amino acid salt CO₂ sorbent can be designed and modified to achieve targeted CO₂ capture performance and sorbent stability or lifetime based on stream conditions, as well as process operating conditions. Stream conditions can include, but are not limited to, CO₂ concentration, CO₂ partial pressure, overall pressure of the stream, H₂O concentration, H₂O partial pressure, other gas constituents, temperature, or relative humidity. Process operating conditions can include but are not limited to inlet air space velocity, overall cycle time, adsorption step cycle time, desorption step cycle time, adsorption to desorption time ratio, evacuation via vacuum, regeneration or desorption temperature, regeneration or desorption pressure, pre- and post-processing unit operations, or regeneration or desorption purge or sweep gas.

In embodiments, the alkali sorbent may comprise Group I elements in the periodic table, i.e., an alkali metal, such as lithium, sodium, and potassium, with sodium and potassium being generally preferred. In other embodiments, the sorbent may comprise Group 2 elements in the periodic table, i.e., an alkaline earth metal, such as beryllium, magnesium, calcium, strontium, barium, and radium with magnesium and calcium being generally preferred. The sorbent may usefully employ alkali metal or alkaline earth metal oxides, hydroxides, carbonates, carbonate hydrates, and bicarbonates. For example, the sorbent may include sodium oxide, sodium hydroxide, sodium carbonate, sodium carbonate hydrate(s), sodium bicarbonate, sodium sesquicarbonate dihydrate, and potassium carbonate, potassium bicarbonate, potassium carbonate hydrate and, potassium sesquicarbonate sesquihydrate, and a combination thereof. The sorbent may employ alkali metal compounds such as sodium aluminate, sodium silicate, sodium phosphate, potassium aluminate, potassium silicate, and potassium phosphate.

Hybrid CO₂ sorbent material (i.e., amino acid salt sorbent plus alkali sorbent) can be synthesized as follows. Equimolar amounts of MOH (in aqueous solution), where M is Li, Na or K, and amino acid or amino sulfonic acid can be mixed to make an amino acid salt solution. Alkali metal carbonates can be added to the amino acid salt solution in various forms including bicarbonates, carbonates and carbonate hydrates. Different amounts of amino acid salts and carbonate precursors can be combined to attain different weight ratios of the hybrid sorbent solution. The final weight ratio of amino acid salt: alkali metal carbonate can be varied from 100:1 to 1:100. Suitable ratios of amino acid salt to alkali metal carbonate may include 100:0, 95:5, 90:10, 85:15, 80:20, 75:25, 70:30, 65:35, 60:40, 55:45, 50:50, 45:55, 40:60, 35:65, 30:70, 25:75, 20:80, 15:85, 10:90, 5:95, and 0:100.

The weight ratio of amino acid salt is calculated as m_{AAS}/(m_{AAS}+m_{AMC})*100, where m_{AAS} is the mass of the amino acid salt and m_{AMC} is the mass of the alkali metal carbonate. Similarly, the weight ratio of the alkali metal carbonate is calculated according to m_{AMC}/(m_{AAS}+m_{AMC})*100.

In embodiments, the amino acid salt sorbent or hybrid sorbent may be deposited on or in a high surface solid support component using various methods, such as, incipient-wetness impregnation, impregnation, washcoating, and ion-exchange. For the hybrid sorbent, the alkali sorbent and amino acid salt sorbent can be mixed in various ratios, as determined by end use application. Exemplary high surface support components include, without limitation, alumina, silica-alumina, titania, silica, zirconia, activated carbon, porous polymers, metal organic framework (MOF), and combinations thereof.

The sorbent and support can be coated onto or impregnated into a substrate, such as a monolith or a laminate. An exemplary substrate may include a ceramic substrate, such e.g., cordierite. When an air stream or flue gas is the CO₂ containing source, mounting the solid amino acid salt sorbent on a substrate yields a suitably low pressure drop for efficient CO₂ removal which is improved over a solvent based sorbent system using alkali carbonates, amines, amino acids, amino acid salts, or combinations thereof. Also, affixing the solid sorbent to the substrate avoids attrition and degradation that can take place for other solid CO₂ sorbents that are fluidized for air or point source streams. Furthermore, affixing the amino acid salt sorbent onto a low pressure drop substrate enables faster adsorption cycle time (seconds to minutes) due to enhanced mass transfer and contacting between the CO₂ containing stream and sorbent in comparison with solid sorbent particles or granules in a traditional packed bed which have relatively slower mass transfer and diffusion rates leading to longer cycle times (minutes to hours).

The combined sorbent and support may be formed into pellets, granules, extrudates, or other shapes suitable for a packed bed sorbent system with known means for producing these particles. In high pressure point source applications for CO₂ capture, such as syngas, the use of solid sorbents in a packed bed significantly reduces the risk of degradation reactions, such as precipitation, polymerization, oxidation, and thermal oxidation, known to be present in solvent-based systems.

To make granules, the amino acid salt sorbent solution can be added to a high surface area and large pore volume support material via various impregnation or similar techniques. Support materials include, but are not limited to, alumina, silica, aluminosilicates, activated carbon and zeolites. The loading of sorbent material on support material can be varied from 10-90 wt %. An example of synthesizing sorbent granules is described in Example 1.

Amino acid salt solutions or hybrid sorbent solutions can be directly impregnated in or coated onto structure materials, such as monolith substrates via dip coating, wash coating or vacuum coating. Monoliths can comprise various materials including alumina, aluminosilicates, cordierite, titania, activated carbon, etc. Coating the amino acid salt solution onto cordierite, titania, alumina and carbon-ceramic composite monoliths is described herein. If the substrate (for example, a monolith) has the desired properties, such as, for example suitable surface area and porosity, the sorbent solution can be directly applied (that is, applied without a high surface area solid support). Alternatively, monoliths such as cordierite can first be coated with a support having desired properties (such as porosity and particle size) through slurry coating, drying and calcination. Exemplary supports include alumina, aluminosilicates, silica, carbons, or others. The amino acid salt solution can then be coated onto or impregnated into the support coated monolith. After coating, excess solution can be removed from substrate channels using high velocity air. After drying, loading of sorbent onto the substrate can be in the range 0.5-4.0 g/in³, where the mass is of the dried sorbent and the volume is the total substrate volume. An example of coating a ceramic monolith with a sorbent and performing adsorption and desorption cycling is demonstrated in Example 1. Example 2 demonstrates CO₂ capture performance (adsorption and desorption cycling) for amino acid salt sorbent tested in commercially relevant process conditions for removal of CO₂ from air over multiple cycles. In one aspect, a structured material assembly (SMA), comprises: a substrate material, a carbon dioxide (CO₂) sorbent, and a desorption material that is responsive to inputted energy to generate heat in-situ to desorb CO₂ from the sorbent in the structured material assembly. The substrate material may be referred to herein as “substrate.” Thus, the terms “substrate material” and “substrate” may be used interchangeably. In embodiments, the substrate material, the sorbent, and the desorption material are arranged such that the substrate material is in a supporting relationship with the sorbent and the desorption material. For example, the sorbent may be deposited on or in the substrate, and the desorption material may be deposited on or in the substrate.

The desorption material on or in the substrate may be electrically conductive (resistivity in a range of 3 to 300 Ohm-m) such that when electricity is applied the desorption material heats the substrate and sorbent. The integration of the desorption material with the solid amino acid salt sorbent on the substrate reduces complexity of the processing steps by eliminating movement of solid particles or liquid solvent into a separate regeneration or desorption vessel.

The desorption material may comprise multiple components, such as resistive components and conductive components. Exemplary desorption materials may include, for example, carbon, silicon carbide, barium titanate, strontium titanate, titanium carbon aluminum alloy, iron aluminum alloy, nickel chrome aluminum alloy, and iron nickel alloy. In embodiments in which the desorption material comprises carbon, such desorption material may for example include at least one of graphite, carbon black, hard carbon, amorphous carbon, and carbon nanotubes.

The carbon can be coated in or on the substrate in various forms such as liquid resins, polymers, or similar. A method for coating a substrate with carbon is described in U.S. application Ser. No. 18/502,262, which is incorporated by reference in its entirety herein.

In an aspect of the invention, a method for coating a substrate with a conductive carbon network comprises providing a three-dimensional substrate, coating the substrate with a phenolic resin solution, curing the coated substrate, and heating the cured substrate to a temperature between 600-1100° C. to pyrolyze the phenolic resin, thus forming a conductive carbon network on, in, or both on and in the substrate. The term “coating” encompasses one or more of dispersing the phenolic resin solution on or in the substrate and impregnating the phenolic resin solution on or in the substrate or a combination thereof. The term “coating” may mean that the phenolic resin is only on the exterior of the three-dimensional surface. However, “coating” may also mean that the phenolic resin is dispersed on the exterior surface and integrated into the interior of the substrate using any method that enables it.

The structured material assembly may be used to capture or remove CO₂ from any source or stream, such as a point source emission (stationary or mobile) or directly from ambient air. The Environmental Protection Agency (EPA) defines “ambient air” as “that portion of the atmosphere, external to buildings, to which the general public has access.” 40 CFR § 50.1 (e). Ambient air is typically 78% nitrogen and 21% oxygen with the extra 1% being made up of a combination of carbon, helium, methane, argon and hydrogen. The concentration of carbon dioxide in the Earth's atmosphere is currently at nearly 412 parts per million (ppm) and rising. This represents a 47 percent increase since the beginning of the Industrial Age, when the concentration was near 280 ppm, and an 11 percent increase since 2000, when it was near 370 ppm.

Embodiments of structured material assemblies and methods of using them for removal of CO₂ from CO₂ containing gases are discussed in PCT/US22/19564 and PCT/US22/27466, both of which are incorporated by reference herein in their entireties. An example of incorporating an amino acid salt sorbent into an SMA is described in Example 4.

The CO₂ sorbent in the structured material assembly may be present in any suitable amount that is effective for CO₂ removal in exposure of the sorbent to ambient air, point source emissions, or other gases containing CO₂. In various embodiments, the CO₂ sorbent is present in the structured material assembly in an amount ranging from 5 to 90% by weight, based on total weight of the structured material assembly. In embodiments, the CO₂ sorbent may be present in an amount of from 5 to 90% by weight, 10 to 50% by weight, 15 to 40% by weight, and 20 to 35% by weight, based on total weight of the structured material assembly. For example, the CO₂ sorbent may be present in an amount of 20, 25, and 30, 35, 40% by weight.

The SMA, containing the amino acid salt sorbent, may be operated in a temperature and/or vacuum swing adsorption process containing a series of batch steps run in a cyclic manner continuously to remove CO₂ from a CO₂ containing gas stream. One such cyclic process includes an adsorption step or phase to adsorb CO₂ from the CO₂ containing gas stream followed by a vacuum step to remove trapped air in the void spaces, followed by a desorption step or phase in which the SMA is enclosed and the temperature of the SMA is increased via integrated electrical heating of the desorption material to release the CO₂ captured on the sorbent in the adsorption step. The CO₂ released from the sorbent during the desorption step can be collected from the SMA via motive force generated by the vacuum pump or similar machinery or alternatively by allowing the pressure to increase within the SMA enclosure (generated by desorption of CO₂) and controlling the outlet gas flow through a nozzle, orifice, or similar device. Upon completion of the desorption step with recovery of the CO₂, the cycle repeats and the SMA is cooled down from desorption temperatures to adsorption temperatures via convective cooling of the gas stream flowing through the SMA or other cooling means. Cooling the sorbent via convective cooling of the CO₂ containing gas stream, such as ambient air in the case of atmospheric CO₂ removal, enables faster cycle times, higher productivity, and reduced process complexity and costs associated with a cooling subsystem.

The adsorption step may be operated under the available conditions of the CO₂ containing gas stream, such as ambient conditions (temperature, pressure, and relative humidity) for air source or elevated temperature and pressure, and lower water content for point sources, such as flue gas or syngas streams, or a combination or blended stream of air and point source. More specifically and advantageously, the solid sorbent performs CO₂ capture in a wide range of ambient air conditions (temperature and relative humidity) at atmospheric pressure with ambient CO₂ concentration, from −7° C. to 45° C. temperatures and 0% relative humidity (RH) to 100% RH without separate removal of H₂O upstream of CO₂ capture. The highest capture performance was seen for 25-100% RH.

This range of temperatures and humidities covers most climatic conditions (Temperate, Continental, and Tropical Koppen climate classification) globally that could be experienced by the sorbent and CO₂ capture process, providing a wide window of potential geographic locations for installation and deployment. Versatility of the amino acid salt CO₂ sorbent is a key feature and benefit when compared to solid amine sorbents, liquid amine solutions, or liquid alkali metal hydroxide/carbonate solutions.

Interestingly, the inventors have found that the CO₂ cyclic working capacity and kinetics of the sorbent are impacted by the relative humidity of the CO₂ containing stream during the adsorption step. This finding is important in situations when the CO₂ containing source is ambient air because the temperature and relative humidity of ambient air are variable throughout the operational period of the sorbent. Ambient air temperature decreases and increases seasonally and/or throughout a day to night cycle. In temperature fluctuations, cooler air can hold relatively less total moisture (vapor pressure decreases as described in the Antoine equation).

The desorption step temperature and time length can be varied by changing the power input to the SMA desorption material as adsorption step stream conditions, such as temperature and relative humidity, vary to maintain target CO₂ product flowrate. The desorption step may be operated under ambient pressure or under vacuum, static (controlled) or variable, or with or without a sweeping (purge) gas but preferentially under vacuum without a purge gas to reduce oxidative degradation and water desorption energy penalty as well as improve CO₂ product purity.

A purge or sweep gas during desorption can be detrimental to CO₂ capture performance. The purge or sweep gas adds complexity to the design and processing steps and time to the desorption phase of the adsorption-desorption cycle. Purge or sweep gas also lowers the CO₂ product purity and potentially the sorbent stability, if a stream containing oxygen is employed. All these drawbacks negatively impact the commercial viability and scalability of the CO₂ capture process.

The level (negative gauge pressure) of vacuum during the desorption phase can be controlled via vacuum pump selection and power input and/or control valves to impact CO₂ working capacity (difference between adsorption and desorption capacity of CO₂ on the sorbent) with higher pressure (less negative gauge pressure) having higher working capacity but lower CO₂ purity and potentially less stability. These factors can be varied together or separately to achieve the targeted CO₂ production, purity, and sorbent lifetime to achieve cost effective large-scale deployment of systems using amino acid salt sorbents for CO₂ removal from the air or CO₂ capture from point sources.

For embodiments where the CO₂ containing source is an air stream, the overall cycle may range from 15 minutes to 125 minutes, but preferably from 30 to 60 minutes. The adsorption step time may range from 10 minutes to 120 minutes but preferably from 20 to 45 minutes depending on ambient conditions of the air. The evacuation step (vacuum) may range from 20 seconds to 5 minutes, but preferably from 1 to 2 minutes. The desorption step may range from 1 minute to 15 minutes, but preferably from 2 to 10 minutes, depending on the CO₂ and H₂O captured on the preceding adsorption step.

For embodiments where the CO₂ containing source is an ambient air stream, the desorption temperature can range from 60° C. to 180° C., or from 70° C. to 150° C., preferably from 80° C. to 120° C. The pressure at the end of evacuation (removing air from void spaces) prior to desorption can range from 760 torr to 1E-4 torr, preferably from 550 torr to 50 torr. The pressure during desorption can be controlled in a range from 850 torr to 1E-4 torr, preferably from 550 torr to 50 torr.

The inventors have demonstrated stable cyclic CO₂ capture performance of the amino acid salt sorbent over 1,000 cycles (˜1 month) with commercially relevant process conditions from an air source including ˜400 ppmv CO₂ in 67% RH air (21% O₂), air cooldown after desorption, evacuation of void air prior to desorption, mild desorption temperature, and no purge/sweep gas during desorption.

The aspects, features, and advantages of the present disclosure will be further appreciated with reference to the following non-limiting Examples, as illustrative of specific embodiments and implementations of the disclosure.

### EXAMPLES

Example 1—Preparation of Amino Acid Salt Sorbent and Hybrid Amino Acid Salt/Alkali Metal Carbonate Sorbent

### Solution 1—Amino Acid Salt Sorbent on a Support-Coated Substrate

20.62 grams of potassium hydroxide solution (45% w/v aqueous solution, Thermo Scientific Chemicals) was added to 15.02 grams of deionized water. 14.38 grams of taurine powder (Thermo Scientific Chemicals, 99% purity) were gradually added to the diluted KOH solution whilst stirring at room temperature, forming a potassium taurate salt solution.

The amino acid salt (potassium taurate) solution (Solution 1) was used to impregnate alumina-coated monolith substrates via dip coating. A 400 cells per square inch (CPSI), 7 mil (0.127 mm) wall thickness high porosity cubic cordierite monolith with an approximate side length of 6″ was vacuum coated with a high surface area alumina in the form of a slurry before drying and calcining. Cores (approximately 1″ length×0.375″ diameter) were extracted from the full-size alumina coated cubic monolith. Wet impregnation was then used to apply Solution 1 to the cores under ambient conditions. High velocity air was used to remove excess solution from the channels after coating. Monolith cores impregnated with Solution 1 were dried for 12 hours at 80° C. in air. Composition details for an exemplary embodiment of a monolith core impregnated with sorbent from Solution 1 (Sample 1) are shown in Table 1.

TABLE 1
Sample 1 coating

| | |
|---|---|
| Alumina-coated monolith core weight (g) | 0.832 |
| Sorbent loading (g) | 0.24 |
| Fully coated monolith core (g) | 1.072 |

Solution 2—Hybrid Sorbent (Amino Acid Salt/Alkali Metal Carbonate Solution) on a High surface Support and on a Support-Coated Substrate

30 grams of NaOH flakes (Thermo Scientific, 98% purity) were slowly added into 371.67 grams of deionized water in a 1.0-liter beaker while mixing to make an aqueous solution of NaOH. A sodium-lysine salt solution was made by gradually adding 109.65 grams of lysine powder (Thermo Scientific, 98% purity) into the above NaOH solution under conditions of mixing and room temperature. 36.89 grams of sodium carbonate monohydrate powder was added to the sodium-lysine salt solution to prepare a hybrid sorbent solution (Solution 2). The final solution (Solution 2) had 28.9 wt % active material (23.2 wt % sodium lysinate and 5.8 wt % sodium carbonate). Deionized water was added to Solution 2 to reduce the active material wt % to 20 wt %.

Diluted Solution 2 was dispersed on a high surface alumina support to make sorbent granules. A Sasol Siralox 40 HPV silica-alumina powder was pre-dried at 120° C. for >8 hours. 50 grams (10 grams of active material) of Solution 2 was dispersed onto 10 grams of dried silica-alumina powder using the incipient wetness method to achieve 50 wt % loading of hybrid sorbent on support. The sample was then dried at 80° C. for 12 hours in air.

The amino acid salt/alkali metal carbonate solution (Solution 2) was also used to impregnate alumina-coated monolith substrates via dip-coating. A 300 cells per square inch (cells/in2), 5 mil (0.127 mm) wall thickness cordierite monolith with approximate cylindrical dimensions of 1.5 inches length×0.7 inches diameter was dried at 120° C. for 12 hours. A high surface area alumina was washcoated onto the monolith in the form of a slurry (˜15 wt % solids) before drying and calcining. The alumina coated monoliths then underwent wet impregnation with Solution 2 under ambient conditions. High velocity air was used to remove excess solution from the channels after coating. Alumina coated monoliths impregnated with sorbent from Solution 2 were dried for 12 hours at 80° C. in air. Composition details for an exemplary embodiment of an alumina coated monolith impregnated with sorbent from Solution 2 (Sample 2) are shown in Table 2.

TABLE 2
Sample 2 coating

| | |
|---|---|
| Bare monolith weight (g) | 1.61 |
| Alumina loading (g) | 1.10 |
| Sorbent loading (g) | 0.71 |
| Fully coated monolith (g) | 3.42 |

### Example 2—Cycle Stability of Amino Acid Salt Sorbents

Five samples were synthesized according to the method described in Example 1. Firstly, a 400 CPSI high porosity cordierite monolith with 7 mil thick walls was coated with high surface alumina (approximately 4.31 g/in³ loading after calcination). Secondly, cores (approximate dimensions 1″ length×0.375″ diameter) were removed and wet impregnated with different amino acid salt solutions (details in Table 3) before drying at 80° C. for ˜12 hours. The alumina loading was the same for all samples. The sorbent/amino acid salt solutions for the five samples included potassium taurate, sodium prolinate, sodium taurate, and sodium lysinate. The sorbent loading for the samples varied but all were between 2 and 3 g/in³.

TABLE 3
Sample details for cyclic testing

| Sample ID | 2-1 | 2-2 | 2-3 | 2-4 | 2-5 |
|---|---|---|---|---|---|
| Alumina | 4.31 | 4.31 | 4.31 | 4.31 | 4.31 |
| Loading | | | | | |
| (g/in3) | | | | | |
| Sorbent/Amino | Potassium | Potassium | Sodium | Sodium | Sodium |
| Acid Salt | Taurate | Taurate | Prolinate | Taurate | Lysinate |
| Sorbent | 2.22 | 2.39 | 2.57 | 2.49 | 2.16 |
| Loading | | | | | |
| (g/in3) | | | | | |
| Substrate | 0.108 | 0.110 | 0.108 | 0.106 | 0.095 |
| Volume (in3) | | | | | |

The five samples were subjected to cyclic carbon dioxide sorption testing in a fast-cycling sorption reactor (0.375″ inner diameter alumina reactor tube). During the CO₂ capture phase of the cycle testing, inlet air and reactor effluent were passed through gas analyzers measuring CO₂ and H₂O concentrations before and after adsorption by the samples, the results of which could be used to calculate total CO₂ adsorbed. A temperature vacuum swing process was used for the desorption phase of the cycle testing. Heat was supplied from heated water via a heat exchanger. A vacuum pump was used to lower reactor pressure to ˜13 PSIG prior to heating and it was maintained at that pressure (+0.2 PSIG) throughout the entire heating phase which lasted 10 minutes and reached a maximum temperature, as measured by a thermocouple in close contact with monolith, of ˜80° C.

After the desorption phase, the reactor was re-pressurized to atmospheric pressure over 30-60 seconds whilst still being maintained at ˜80° C. An adsorption phase was started by flowing synthetic air (˜21 vol % O₂, ˜400 ppmv CO₂, balance N₂) with a flow rate of 300 hr⁻¹ weight hourly space velocity (defined as mass of amino acid salt divided by mass of air flowed in one hour) through the monolith whilst simultaneously cooling the sorbent sample by flowing chilled water through the heat exchanger. Chilled water flow rates were controlled to achieve cooling from 80° C. down to 30° C. in approximately 100 seconds, which mimicked the cooling rate achieved in Example 4 through convective cooling from air flow only in a full-size monolith. This controlled cooling enabled stability assessment under commercially relevant cooling process conditions. Additionally, the temperatures, pressures, and lack of purge gas in the cyclic carbon dioxide sorption testing represented commercially relevant conditions.

Further, using flowing air to cool the sample as mimicked in the sorption testing, as opposed to a complex-engineered cooling system involving inert gases or slow free-cooling under vacuum, has performance, efficiency, and economic benefits on a unit cost basis (per tonne of CO₂ captured).

The chiller fluid was switched off when the sorbent sample temperature reached 16° C. and remained off during the remainder of the adsorb phase. The adsorb phase air was humidified by bubbling through a water impinger containing DI water until approximate saturation. Separate dry and humidified air streams were blended to achieve a relative humidity of 67% at room temperature (˜16° C.). The adsorption phase lasted 35 minutes and then the cycle was repeated beginning with lowering reactor pressure.

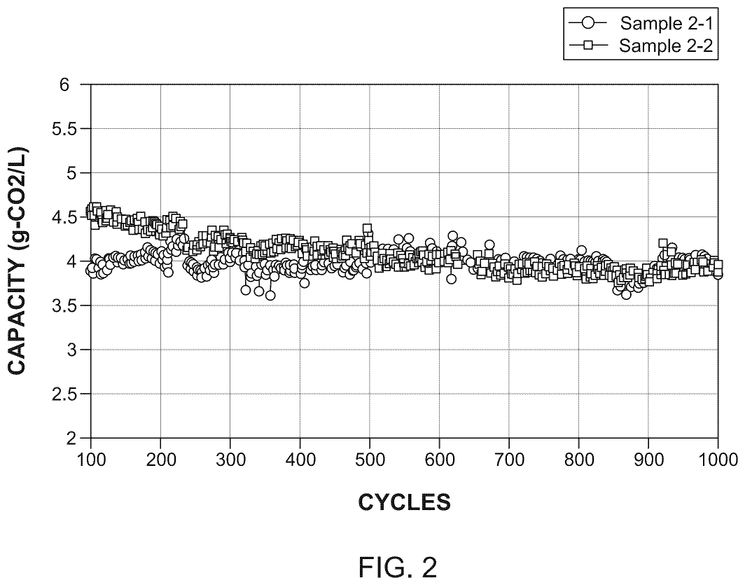

The potassium taurate samples, Sample 2-1 and Sample 2-2, were evaluated through 1000 CO₂ sorption cycles, which corresponds to more than one month of runtime under realistic commercial process conditions. FIG. 2 shows cyclic stability of adsorption capacity of the two potassium-taurate coated substrates up to 1000 cycles. Both samples demonstrated extremely good adsorption capacity cyclic stability, even with air flowing through the monolith as it cooled from 80° C. The adsorption capacity of both samples 2-1 and 2-2 were around 4 g CO₂/L for the entirety of the 1000 cycles.

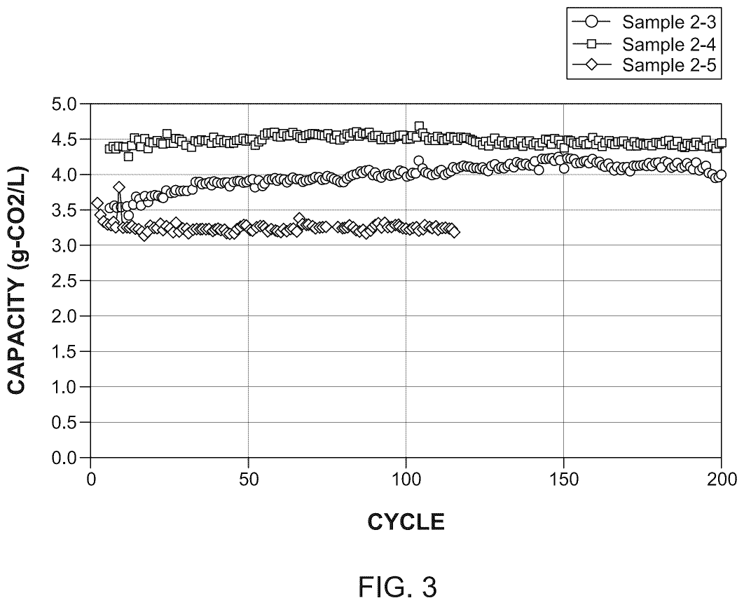

The sodium prolinate, sodium taurate and sodium lysinate samples, Samples 2-3, 2-4, and 2-5, respectively, were evaluated through 100 CO₂ sorption cycles, FIG. 3 shows cyclic stability of adsorption capacity for samples 2-3, 2-4, and 2-5. As can be seen, these samples demonstrated cyclic stability over more than 100 cycles.

### Example 3—Effects of Temperature and Relative Humidity on Sorbent Performance

The effects of adsorption temperature and desorption temperature were investigated on samples 2-3 and 2-4 from Example 2 and sample 3-1 from Example 3, the details of which are shown in Table 3 below. To investigate desorption temperature all process variables remained the same as in Example 2 except for desorption temperature which was varied from 60-110° C. and the adsorption duration, which was 35 minutes for desorption temperature range 60-90° C., and 45 minutes for desorption temperature range 100-110° C.

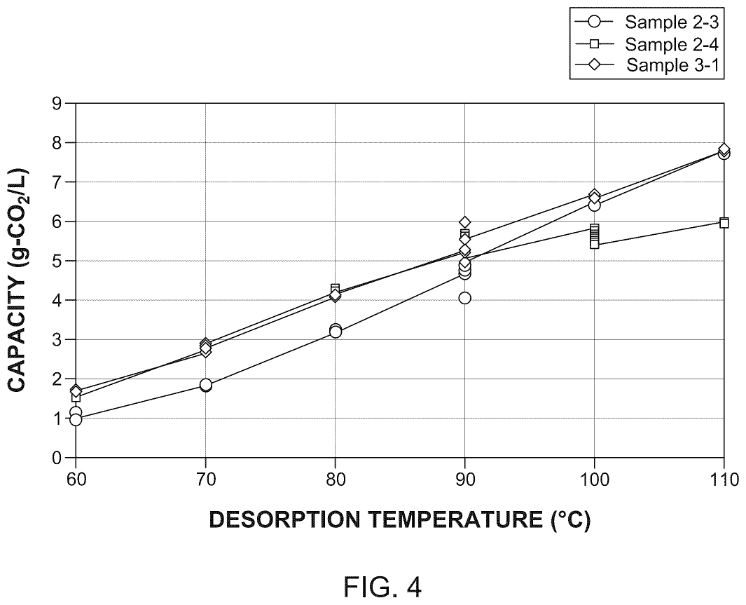

FIG. 4 is a graph showing adsorption capacity of the samples as a function of desorption temperature. As can be seen, as desorption temperature increased, adsorption capacity of the samples increased. This result was expected in a temperature vacuum swing adsorption process.

For 60° C. desorption the volumetric capacities lie in the range 1-2 g-CO₂/L whereas for 110° C. desorption temperature the volumetric capacity range increased to 6-8 g-CO₂/L. This relationship was observed for all samples. For the potassium taurate sorbent, almost a doubling in capacity was observed when desorption temperature was increased from 80 to 110° C.

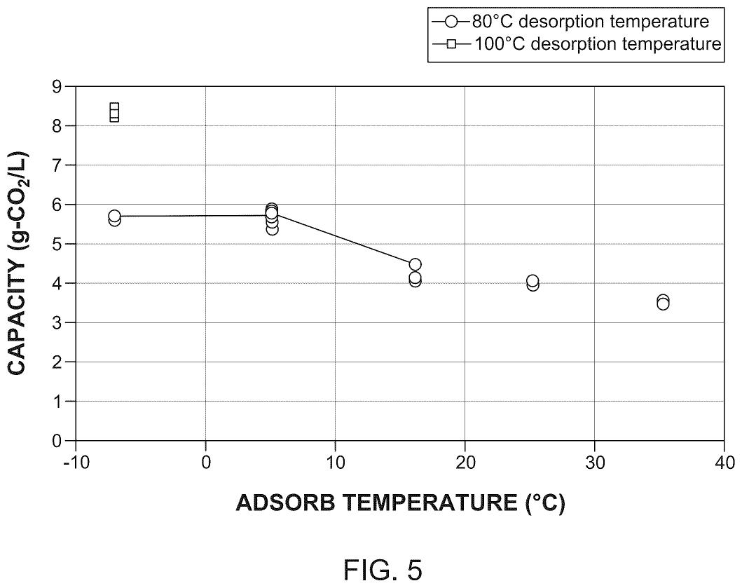

The effects of adsorption temperature were also evaluated. To assess the effects of adsorption temperature, desorption temperature was fixed at 80° C. (except for one test when the desorption temperature was 100° C., as indicated in FIG. 5) and adsorption temperature was varied. FIG. 5 is a chart showing adsorption capacity as a function of adsorption temperature.

For this testing, adsorption temperature was defined as the measured temperature when the chilled water circulation was stopped. For adsorption temperatures 5° C., 15° C. and 25° C., the relative humidity was maintained at ˜67%, whereas at adsorption temperature of 35° C., relative humidity was ˜40%. Cooling to −7° C. was slow and took most of the adsorption phase which meant that the relative humidity was significantly lower than 67% for most of the adsorption phase.

When the desorption temperature was changed to 100° C., the adsorption duration was increased to 1 hour to account for higher capacity. The data in FIG. 5 shows increasing capacity as adsorption temperature is lowered. It can also be seen that the capacities are similar at −7° C. and 5° C. Without being bound by theory, it is believed that this result is likely due to the lower average relative humidity at the lower temperature due to the slow cooling.

Advantageously, the results showed that the sorbent samples could operate over a wide range of adsorption temperatures and could operate significantly below freezing conditions with no significant adverse effects on adsorption capacity performance.

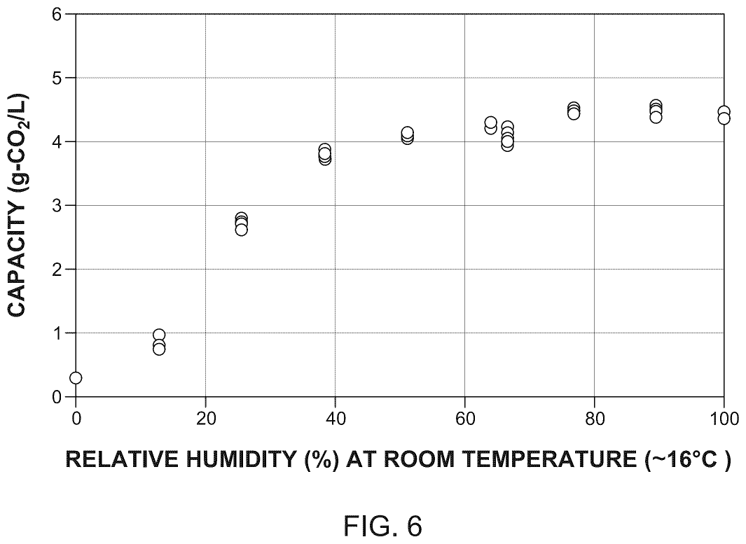

Sample 3-2, the compositional details of which are shown in Table 3 below, was used to understand the effects of relative humidity on adsorption capacity. The same processing conditions as described in Example 2 were used except for relative humidity (RH, as defined at 16° C.), which was varied from 0-100%. Humidification was achieved by bubbling adsorption synthetic air (˜21 vol % O₂, ˜400 ppmv CO₂, balance N₂) through a water impinger containing DI water until approximate saturation. Separate dry and humidified air streams were blended to achieve desired relative humidity. FIG. 6 is a chart showing adsorption capacity as a function of adsorption relative humidity at 16° C. As can be seen in FIG. 6, from 0 to 50% RH, there was a marked increase in capacity. At 50% RH and above, the increase in capacity was much lower.

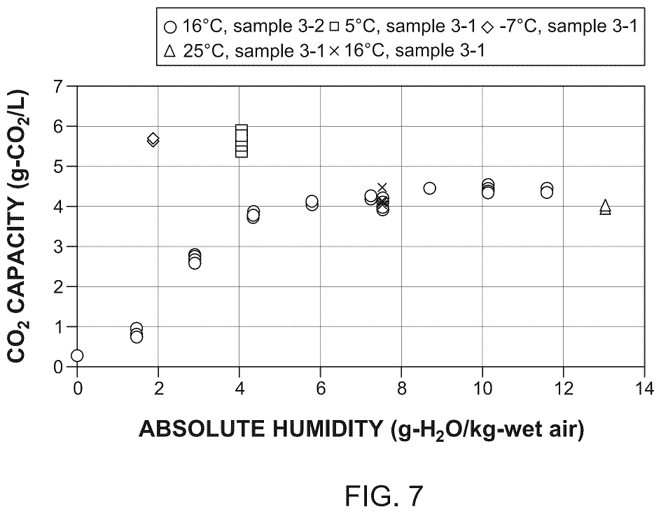

Data in FIG. 5 and FIG. 6 can be expressed in terms of absolute humidity as shown in FIG. 7. The adsorption temperatures are shown in the legend. As can be seen, absolute humidity alone is not a reliable indicator of CO₂ cyclic capacity. As can be seen ambient air streams having similar absolute humidity can have very different CO₂ cyclic capacities. For example, the CO₂ cyclic capacity for −7° C. adsorption with ˜1.9 g-H₂O/g-wet air (5.7 g—CO₂/L) is very different from the CO₂ cyclic capacity for 16° C. adsorption with 1.4 g-H₂O/g-wet air (˜0.8 g-CO₂/L). This comparison shows that temperature influences CO₂ cyclic capacity. Advantageously, the amino acid salt sorbent described herein has demonstrated good sorbent performance at low temperatures where absolute humidity is very low.

TABLE 3
Sample details for parametric process conditions testing

| Sample ID | 3-1 | 3-2 |
|---|---|---|
| Alumina Loading (g/in3) | 4.31 | 3.52 |
| Sorbent/Amino Acid Salt | Potassium Taurate | Potassium Taurate |
| Sorbent Loading (g/in³) | 2.613 | 2.17 |
| Substrate Volume (in³) | 0.117 | 0.112 |

### Example 4—Testing of Amino Acid Salt Sorbent Dispersed on Large Monolith Substrate (6×6×6″) with Integrated Heating in Direct Air Capture (DAC) Apparatus

A full-sized high porosity cordierite monolith, as would be used in commercial applications, was prepared for testing. The cordierite monolith substrate was initially cubic (approximately 6×6×6″) with 400 CPSI channel density and 7 mil thick walls. The substrate was made to be electrically conductive and then was coated with high surface area alumina (3.38 g/in³ post 125° C. dry). Approximately 0.2″ of outer walls was removed, by cutting and sanding, from two opposing sides.

An aqueous sorbent solution of 40 weight % potassium taurate was applied to the alumina-coated, electrically conductive monolith via wet impregnation. Excess solution in the channels was removed by forced air using an air knife, and the sample (that is, the alumina-coated electrically conductive, monolith with sorbent applied) was dried at approximately 80° C. in air overnight. The dried sample contained 517 g of potassium taurate sorbent. A highly conductive silver-coated copper paint was applied to each cut face of the dried sample to act as integrated electrodes. The resistance between the integrated electrodes was approximately 2.2Ω.

The prepared sample underwent CO₂ adsorption and desorption cycling in a reactor and cyclic CO₂ sorption performance was assessed. Ambient outside air was used for adsorption without any conditioning except filtration to remove particulates. As such, temperature and humidity of adsorption air was determined by local weather conditions. Gas analyzers were used to measure mass flows of CO₂ and H₂O in the adsorption gas at points before and after the sample. The resulting data was used to calculate cyclic CO₂ capacity.

Desorption occurred via a temperature-vacuum swing. A voltage was applied across the electrically conductive sample between the two integrated electrodes to heat the sample. Current flowed through the sample and converted to heat which released the CO₂ from the sorbent. Releasing the CO₂ from the sorbent regenerated the sorbent for use in the next cycle. Without being bound by theory, a person having ordinary skill in the art will understand that the conductive sample is heated according to the Joule heating principle, where the passage of an electric current through a conductor produces heat.

Temperature was measured at points within the sample with a fiber optic interrogator system (ODiSI 6000 Series, Luna Inc.) capable of measuring temperature along its entire length with high spatial resolution. A fiber optic cable (<0.2 mm diameter) was woven through the flow channels of the sample to measure temperature while allowing gas flow through the channels (>1 mm diameter). Temperatures were recorded across 16 channels and one surface. A temperature controller used the temperatures inputs as a process variable (PV) with a set point (SP) to modulate the power input, via a silicon-controlled rectifier (SCR), to the sample that maintained a temperature for desorption.

The reactor (a 16″ cubic vacuum chamber) was depressurized to −13 PSIG and maintained ±0.2 PSIG throughout desorption using a vacuum pump. Joule heating was used to heat the sample to 140° C., as measured by the peak temperature in the hottest channel. The average temperature across all channels was 85-90° C. Peak temperature was maintained for 10 minutes. For the last 0.4 minutes of desorption, a ⅛″ diameter orifice in the reactor connected to room air was opened whilst the pump remained on, which flushed the chamber and aided CO₂ collection. The vacuum pump and heating were then switched off, and the reactor repressurized to atmospheric pressure through the orifice.

After re-pressurization, ambient outside air flowed through the reactor via an induction fan located downstream of the sample. The flow rate was approximately 2.65 m³/h, which corresponds to ˜370 hr⁻¹ weight hourly space velocity referenced to amino acid salt mass. This flow rate cooled the sample within 3 minutes. The adsorption phase would continue until the effluent CO₂ concentration was within 10 parts per million of the inlet CO₂ concentration. Then the cycle of desorption/regeneration and adsorption would be repeated.

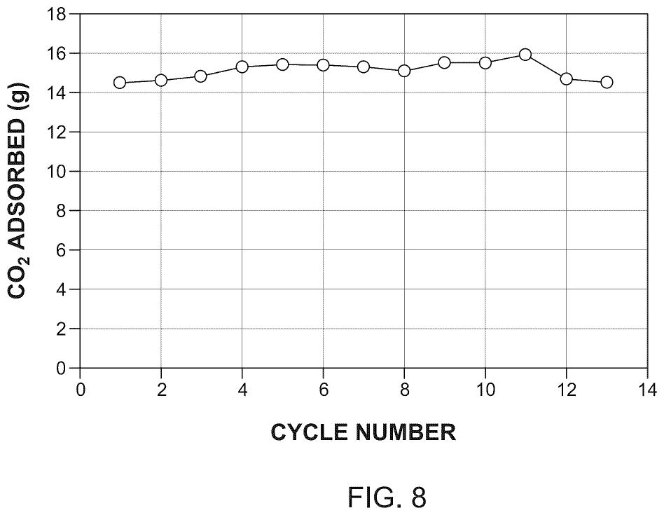

FIG. 8 is a chart showing CO₂ adsorption capacity in grams as a function of cycle number. As shown, the sample captured around 14 to 16 grams of CO₂ per cycle, which is excellent capture efficiency under commercially relevant conditions. This example demonstrates the use of an amino acid salt sorbent for CO₂ capture and integration with a desorption method (electric resistive heating) in commercially relevant conditions in a commercially relevant size.

### Example 5—Superior Performance of Hybrid Amino Acid Salt/Alkali Metal Carbonate Sorbents Over Alkali Metal Carbonate Only or Amino Acid Only Sorbents

A sodium lysinate/sodium carbonate sample, a sodium carbonate sample, and a pure lysine sample were prepared to study CO₂ capacities of hybrid amino acid salt/alkali metal carbonates versus pure amino acid sorbent or alkali metal carbonate sorbent. Table 4 shows the compositions for the samples tested in Example 5 and the adsorption CO₂ capacities.

TABLE 4
Sorbent compositions tested in Example
5 with 120° C. regeneration temperature

| | | | | Average CO₂ |
|---|---|---|---|---|
| | | Sodium | Sodium | Adsorption |
| Sample | Lysine | lysinate | carbonate | Capacity (wt %, g- |
| ID | (wt %) | (wt %) | (wt %) | CO₂/g-granule) |
| 5-1 | 0 | 0 | 100 | 0.9 |
| 5-2 | 0 | 80 | 20 | 6.84 |
| 5-3 | 100 | 0 | 0 | 2.65 |

For all samples, the sorbent compositions were dispersed (50 wt %) on a SiO₂/Al₂O₃ support (50 wt %). Approximately 0.5 grams of 250-425 μm granules of samples were subjected to adsorption-desorption cycling within a small bench top reactor (0.75″ inner diameter alumina reactor tube). Reactor effluent was passed through gas analyzers where CO₂ and water concentrations were measured, the results of which could be used to calculate total CO₂ adsorbed and desorbed. During adsorption, synthetic air (˜21 vol % O₂, ˜400 ppmv CO₂, balance N₂) from a cylinder flowed through the granules. The air was pre-saturated with DI water using a bubble impinger. Desorption was achieved through a temperature swing where heat was supplied from heating tape wrapped around the alumina tube. Desorption was performed at 120° C. and under 100 mL/min of dry N₂ flow. Prior to cycling, they underwent a pre-treatment step which consisted of heating the sample to the corresponding regeneration temperature and holding at this temperature for 120 minutes under 100 ml/min of dry N₂ flow.

Table 4 shows average CO₂ capacity during adsorption for an amino acid salt/alkali metal carbonate sorbent composition compared to the amino acid sorbent or alkali metal carbonate sorbent. Sodium lysinate concentration is referenced to the mass of the sorbent excluding the support material. CO₂ capacity is provided in wt %, defined as weight of CO₂ captured on sorbent during adsorption step divided by the weight of the granules, which includes the sorbent and support. Each data point represents the averages of at least four (4) adsorption/desorption cycles. The data shows a CO₂ adsorption capacity of less than 1 wt % for a sorbent composition of 100% sodium carbonate, a CO₂ adsorption capacity of around 6.8 wt % for a sorbent composition having 80% sodium lysinate/20% sodium carbonate, and a CO₂ adsorption capacity of around 2.7 wt % for 100% lysine sorbent. The amino acid salt sorbent combined with Na₂CO₃ demonstrated an increase in cyclic CO₂ capacity of many multiples (˜7×) in comparison to the alkali metal carbonate alone. The 80% sodium lysinate/20% carbonate sorbent also demonstrated a CO₂ capacity more than double that of pure lysine.

1-32. (canceled)

33. A solid amino acid salt sorbent for removing CO₂ from a CO₂ containing gas, the sorbent comprising an amino acid constituent and an alkali metal constituent.

34. The solid amino acid salt sorbent of claim 33, further comprising a support component arranged in a structural relationship with the amino acid constituent and alkali metal constituent.

35. The solid amino acid salt sorbent of claim 33, wherein the amino acid constituent comprises one or more of an amino carboxylic acid or an amino sulfonic acid.

36. The solid amino acid salt sorbent of claim 33, wherein the alkali metal constituent comprises an alkali metal group element or alkaline earth metal group element from the periodic table.

37. The solid amino acid salt sorbent of claim 33, wherein the solid amino acid salt sorbent comprises one or more of potassium taurine salt, sodium proline salt, sodium taurine salt, sodium lysine salt, potassium lysine salt, lithium lysine salt, potassium glycine salt, sodium glycine salt, lithium glycine salt, histidine sodium salt, taurine sodium salt, aspartic acid sodium salt, asparagine sodium salt, alanine sodium salt, or leucine sodium salt.

38. A hybrid sorbent comprising the solid amino acid salt sorbent of claim 33 and an alkali metal sorbent.

39. A structured material assembly for removing CO₂ from a CO₂ containing gas, comprising a substrate, the solid amino acid sorbent comprising an amino acid constituent and an alkali metal constituent, and a desorption material integrated into the structured material assembly, which is responsive to inputted energy to generate heat to desorb CO₂ from the sorbent.

40. The structured material assembly of claim 39, further comprising a support component arranged in a structural relationship with the sorbent.

41. The structured material assembly of claim 39, wherein the substrate comprises one or more of cordierite, titania, silica-alumina, silica, alumina, mullite, carbon, or silicon carbide (SiC).

42. The structured material assembly of claim 39, wherein the substrate is in monolithic form.

43. The structured material assembly of claim 39, wherein the desorption material comprises one or more of carbon, silicon carbide, barium titanate, strontium titanate, titanium carbon aluminum alloy, iron aluminum alloy, nickel chrome aluminum alloy, or iron nickel alloy.

44. The structured material assembly of claim 40, wherein the support component comprises one or more of alumina, titania, silica, zirconia, activated carbon, porous polymers, or metal organic framework (MOF).

45. A process for removal of CO₂ from a CO₂-containing gas using a solid amino acid salt sorbent, the process comprising:
providing an assembly comprising a solid amino acid salt sorbent, a support component, and a desorption material integrated into the assembly, wherein the solid amino acid salt sorbent comprises an amino acid constituent and an alkali metal constituent,
contacting the CO₂-containing gas with the solid amino acid salt sorbent whereby CO₂ is adsorbed on the solid amino acid salt sorbent in an adsorption phase, and
heating the desorption material to desorb previously adsorbed CO₂ from the solid amino acid salt sorbent in a desorption phase, and
wherein a single adsorption phase and a single desorption phase is a single CO₂ adsorption cycle.

46. The process of claim 45, wherein the solid amino acid salt sorbent comprises one or more of sodium lysinate, potassium lysinate, lithium lysinate, potassium glycinate, sodium glycinate, lithium glycinate, histidine sodium salt, taurine sodium salt, aspartic acid sodium salt, asparagine sodium salt, alanine sodium salt, leucine sodium salt, or taurine potassium salt.

47. The process of claim 45, further comprising cooling the sorbent by flowing ambient air through the assembly after desorption of CO₂ from the solid amino acid salt sorbent, wherein said cooling can take place during an adsorption phase.

48. The process of claim 45, wherein the CO₂-containing gas is air.

49. The process of claim 45, where pressure in the assembly is reduced by vacuum after the adsorption phase and before the desorption phase.

50. The process of claim 45, wherein the desorption temperature range is 60° C. to 150° C.

51. The process of claim 45, wherein the CO₂-containing gas has a relative humidity of 20% to 100%.

52. The process of claim 45, wherein an adsorption capacity of the solid amino acid salt sorbent in grams CO₂ per liter of assembly volume decreases by 10% or less for 1000 or more adsorption cycles.
